(19) United States
(12) Patent Application Publication
(10) Pub. No.: US 2014/0214600 A1
(43) Pub. Date: Jul. 31, 2014

(54) Assisting A Consumer In Locating A Product Within A Retail Store

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/756,307

(22) Filed: Jan. 31, 2013

(51) Int. Cl. G06Q 30/06

(52) U.S. Cl. CPC G06Q 30/0639
USPC 705/26.8

(57) ABSTRACT

A computer-implemented method is disclosed herein. The method includes the step of storing locally, at an augmented reality device worn by a consumer, a shopping list of products that a consumer desires to purchase in a retail store. The method also includes the step of identifying, with a processing device of a commerce server, a location within the retail store of a product on the shopping list and a location of the consumer within the retail store. The method also includes the step of transmitting, with the processing device, directions from the location of the consumer to the location of the product, the directions being transmitted to an augmented reality device worn by the consumer in the retail store. The method also includes the step of receiving, with the processing device, a video signal from a camera of the augmented reality device as the consumer moves through the retail store.

### BACKGROUND INFORMATION

1. Field of the Disclosure

The present invention relates generally to assisting a consumer with locating a product in a retail store. In particular, visual highlighting of a product on a shelf in the retail store can be accomplished through an augmented reality device worn by the consumer.

2. Background

Many consumers visit supermarkets and superstores when shopping for products such as groceries, office supplies, and household wares. Typically, these stores can have dozens of aisles and/or sections. Accordingly, traversing these aisles looking for specific products may be a challenging experience. Locating the general vicinity of the product is a first part of the process. Once the consumer arrives at the aisle of the product of interest, the particular product must be identified from among all of the products displayed within the aisle. Many products are sold in small packages and therefore difficult to see easily. Further, the packaging of most products is designed to draw attention, so the consumer's vision can be inundated with numerous items attracting focus.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is an example schematic illustrating a system according to some embodiments of the present disclosure.

FIG. 2 is an example block diagram illustrating an augmented reality device unit that can be applied in some embodiments of the present disclosure.

FIG. 3 is an example block diagram illustration a commerce server that can be applied in some embodiments of the present disclosure.

FIG. 4A is a first example of the view through a display of an augmented reality device, looking down an aisle as the consumer is shopping in some embodiments of the present disclosure.

FIG. 4B is a second example of the view through a display of an augmented reality device, looking down an aisle as the consumer is shopping in some embodiments of the present disclosure.

FIG. 4C is a third example of the view through a display of an augmented reality device, looking down an aisle as the consumer is shopping in some embodiments of the present disclosure.

FIG. 4D is a fourth example of the view through a display of an augmented reality device, looking down an aisle as the consumer is shopping in some embodiments of the present disclosure.

FIG. 4E is a fifth example of the view through a display of an augmented reality device, looking down an aisle as the consumer is shopping in some embodiments of the present disclosure.

FIG. 5 is an example flow chart illustrating a method that can be carried out according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Embodiments of the present disclosure can assist a consumer with purchasing products in a retail store. Making a shopping experience more efficient can be a valuable tool for marketing and drawing additional consumers into the retail store. One method of increasing shopping efficiency is to minimize the time that the consumer spends searching for products on his or her shopping list. It is contemplated by the present disclosure that a shopping list of products to be purchased can be generated and transmitted to a commerce server associated with the retail store. The commerce server can analyze the shopping list with respect to the products offered for sale in the retail store. A product database accessible by the commerce server can store the locations of all of the products within the retail store and in turn provide assistance to the consumer in locating a product on his or her shopping list. Communication between the commerce server and the consumer can be facilitated by an augmented reality device worn by the consumer while shopping in the retail store.

A product shopping list can be generated by the consumer and transmitted to a commerce server. The product shopping list can be generated by the consumer in several ways. The consumer can enter the shopping list on an electronic computing device located external to the retail store. The shopping list can be generated with an electronic computing device possessed by the consumer. An electronic computing device used by a consumer can be a laptop computer, a desktop computer, a smart-phone, a tablet, an e-reader, or any other electronic computing device operable to generate and transmit a shopping list signal. Alternatively, the shopping list can be generated inside the retail store.

Another method for generating the shopping list can include using the augmented reality device to communicate with the commerce server. This method can be implemented by the consumer wearing the augmented reality device and audibly creating the shopping list. The commerce server can interpret the audio messages received from the consumer and transmit the shopping list back to a display of the augmented reality device so that the consumer can visually confirm that the shopping list has been entered correctly.

After the shopping list has been received by the commerce server, the processing device can then communicate with the product database to determine the location of each of the products within the retail store. The shopping list can be sorted by the commerce server so as to minimize the total travel and therefore minimize the time spent in the retail store by the consumer.

The commerce server can also identify the location of the consumer within the retail store. For example, the augmented reality device can emit a signal corresponding to the position of the consumer in the retail store. Based on the location of the consumer and the location of the next product on the shopping list, the commerce server can send directions to the consumer so that the consumer can move in the direction of the desired product. When the product is visible in the field of view of the camera, the commerce server can be configured to send a proximity signal resulting in a change in the display of the augmented reality device. The proximity signal can result in a highlighting feature appearing on the display.

The highlighting feature can augment the natural view of the product and will help the consumer locate the desired product among the proximate products that are disposed on the store shelves. Highlighting features in various embodiments of the present disclosure can be any change in the display of the augmented reality device that distinguishes the desired product from those products that are immediately adjacent to or otherwise proximate to the desired product. For example, these features can include, but are not limited to, a graphical outline placed around the product or other visually observable features such a words, phrases, symbols, differential illumination, and/or variations in focus.

Graphical outlines or overlays can generally include various line shapes, types and widths that become visible on the display to augment the natural view of the product. The graphical overlays can envelope the desired product on the shelf to draw the attention of the consumer. Overlay shapes can include circles, ovals, squares, rectangles and other regular or irregular shapes determined to be adequate highlighting configurations. Overlay line types can include solid, broken, dashed, or other desired configurations.

Alternatively, or in addition to the graphical outlines, words or phrases such as “Here is the next product” with arrows pointing to the product on the shelf can become visible on the display of the augmented reality device. Further, visual contrasting or differential illumination can be applied to highlight the desired product. For example, the product highlighting arising in response to the proximity signal can include providing a focused view of the desired product with a purposeful “fuzziness” or unfocused view of the products adjacent to the desired product.

In some embodiments of the present disclosure, the head mountable unit can transmit more than one signal that is received by the commerce server. A video signal transmitted by the augmented reality device can be processed to identify the product that is being pursued and other signals can be processed to complement the video analysis. For example, as a video signal is being received the commerce server can also receive a position signal from the head mountable unit. The position signal can be correlated with data in the product database. The position signal can confirm that the consumer is proximate to the product being pursued and the product should be contained in the video signal.

The commerce server can also receive a direction signal transmitted by the head mountable unit. The direction of the consumer can be contained in the direction signal. The data in the direction signal can be correlated to data in the product database to confirm that the product to be highlighted is in the direction that the consumer is facing.

The commerce server can also receive an orientation signal transmitted by the head mountable unit. The orientation of the consumer's head can be contained in the orientation signal. For example, the consumer may be looking upwardly or downwardly. The data in the orientation signal, the direction signal, and the position signal can be correlated with data in the product database and the consumer's location to confirm that the product being pursued should be within the consumer's field of view. Further, since the field of view of the camera 42 overlaps the consumer's field of view, the data in the orientation signal, the direction signal, and the position signal can confirm that the product being pursued should be within the field of view of the camera of the augmented reality device.

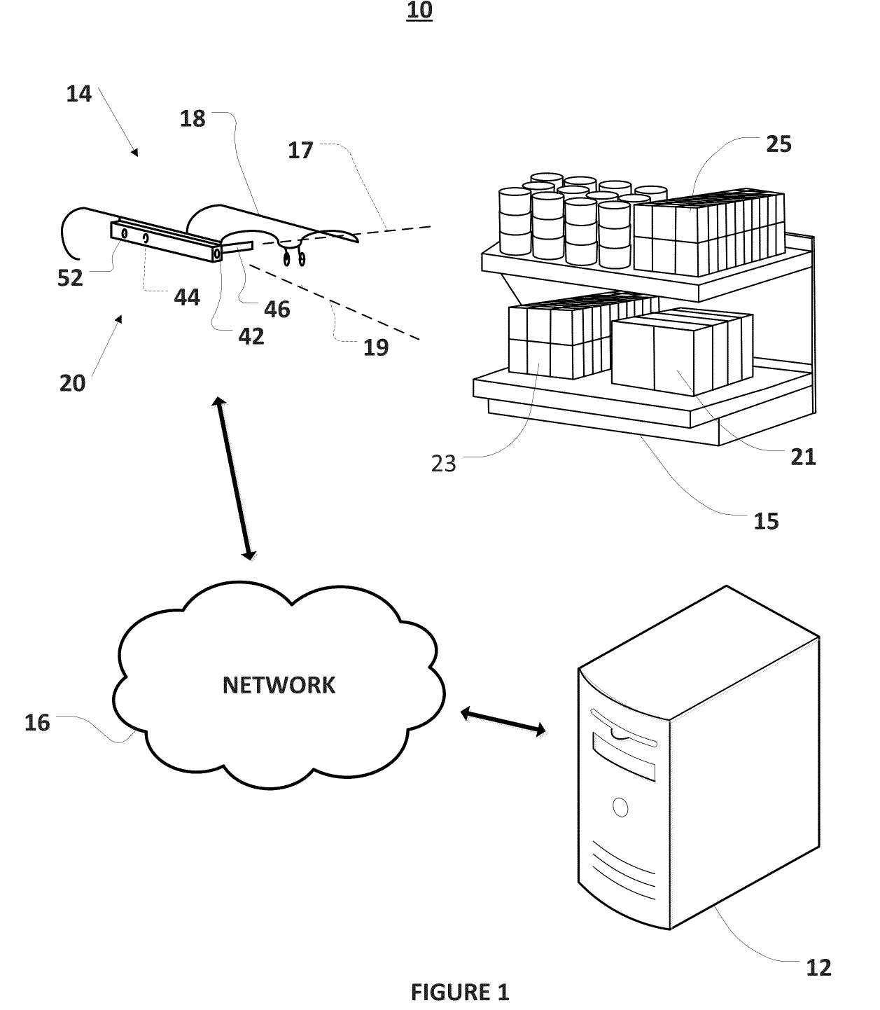

FIG. 1 is a schematic illustrating a consumer assistance system 10 according to some embodiments of the present disclosure. The consumer assistance system 10 can execute a computer-implemented method that includes the step of receiving a shopping list of products at a processing device of a commerce server 12. The shopping list can be generated by a consumer who desires to purchase products in a retail store. The commerce server 12 can identify the location of a product on the shopping list within the retail store and can also identify the location of the consumer within the retail store. The processing device of the commerce server 12 can then transmit directions from the location of the consumer to the location of the product to an augmented reality device. The augmented reality device can be a head mountable unit 14 worn by the consumer. It is noted that the shopping list can be stored locally, on the head mountable unit 14. The exemplary head mountable unit 14 includes a frame 18 and a communications unit 20 supported on the frame 18.

The commerce server 12 can receive video signals from a camera 42 of the head mountable unit 14 as the consumer moves through the retail store. Video signals can be transmitted from the head mountable unit 14 in which a portion of store shelving 15 is in the field of view of the camera 42. The field of view of the camera 42 is illustrated schematically by dashed lines 17 and 19. One or more products, such as products 21, 23, and 25, can be disposed on the shelving 15 and be within the field of view of the camera 42. It is noted that embodiments of the present disclosure can be practiced in retail stores not using shelving and in retail stores partially using shelving.

The commerce server 12 can determine when a product currently being pursued is in the field of view of the camera 42 and transmit a proximity signal to the head mountable unit 14. The proximity signal can result in a change to a display 46 of the augmented reality device 14 to highlight the product being pursued on the display 46. It is noted that the device 14 can determine when it is in proximity, as it may use an inherent gyroscope, compass, accelerometer, or clock to track from a known position orientation. Also, the commerce server 12 can send direction information from that known position to a desired product.

The one or more signals transmitted by the head mountable unit 14 and received by the commerce server 12 can be transmitted through a network 16. As used herein, the term “network” can include, but is not limited to, a Local Area Network (LAN), a Metropolitan Area Network (MAN), a Wide Area Network (WAN), the Internet, or combinations thereof. Embodiments of the present disclosure can be practiced with a wireless network, a hard-wired network, or any combination thereof.

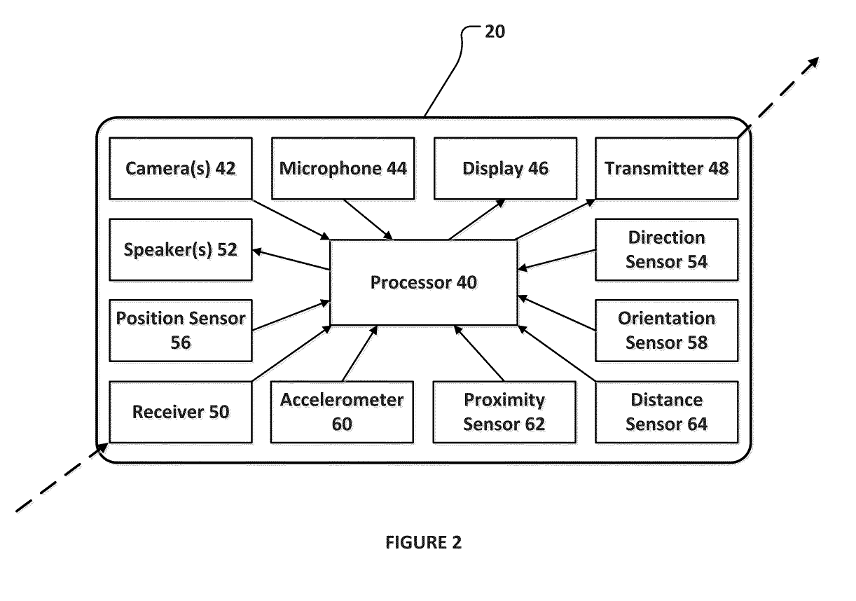

FIG. 2 is a block diagram illustrating exemplary components of the communications unit 20. The communications unit can include a processor 40, one or more cameras 42, a microphone 44, a display 46, a transmitter 48, a receiver 50, one or more speakers 52, a direction sensor 54, a position sensor 56, an orientation sensor 58, an accelerometer 60, a proximity sensor 62, and a distance sensor 64.

The processor 40 can be operable to receive signals generated by the other components of the communications unit 20. The processor 40 can also be operable to control the other components of the communications unit 20. The processor 40 can also be operable to process signals received by the head mount unit 14. While one processor 40 is illustrated, it should be appreciated that the term “processor” can include two or more processors that operate in an individual or distributed manner.

The head mount unit 14 can include one or more cameras 42. Each camera 42 can be configured to generate a video signal. One of the cameras 42 can be oriented to generate a video signal that approximates the field of view of the consumer wearing the head mountable unit 14. Each camera 42 can be operable to capture single images and/or video and to generate a video signal based thereon. The video signal may be representative of the field of view of the consumer wearing the head mountable unit 14.

In some embodiments of the disclosure, cameras 42 may be a plurality of forward-facing cameras 42. The cameras 42 can be a stereo camera with two or more lenses with a separate image sensor or film frame for each lens. This arrangement allows the camera to simulate human binocular vision and thus capture three-dimensional images. This process is known as stereo photography. The cameras 42 can be configured to execute computer stereo vision in which three-dimensional information is extracted from digital images. In such embodiments, the orientation of the cameras 42 can be known and the respective video signals can be processed to triangulate an object with both video signals. This processing can be applied to determine the distance that the consumer is spaced from the object. Determining the distance that the consumer is spaced from the object can be executed by the processor 40 or by the commerce server 12 using known distance calculation techniques.

Processing of the one or more, forward-facing video signals can also be applied to determine the identity of the object. Determining the identity of the object, such as the identity of a product in the retail store, can be executed by the processor 40 or by the commerce server 12. If the processing is executed by the commerce server 12, the processor 40 can modify the video signals limit the transmission of data back to the commerce server 12. For example, the video signal can be parsed and one or more image files can be transmitted to the commerce server 12 instead of a live video feed. Further, the video can be modified from color to black and white to further reduce transmission load and/or ease the burden of processing for either the processor 40 or the commerce server 12. Also, the video can be cropped to an area of interest to reduce the transmission of data to the commerce server 12.

In some embodiments of the present disclosure, the cameras 42 can include one or more inwardly-facing camera 42 directed toward the consumer's eyes. A video signal revealing the consumer's eyes can be processed using eye tracking techniques to determine the direction that the consumer is viewing. In one example, a video signal from an inwardly-facing camera can be correlated with one or more forward-facing video signals to determine the object the consumer is viewing.

The microphone 44 can be configured to generate an audio signal that corresponds to sound generated by and/or proximate to the consumer. The audio signal can be processed by the processor 40 or by the commerce server 12. For example, verbal signals can be processed by the commerce server 12 such as “this product appears interesting.” Such audio signals can be correlated to the video recording.

The display 46 can be positioned within the consumer's field of view. Video content can be shown to the consumer with the display 46. The display 46 can be configured to display text, graphics, images, illustrations and any other video signals to the consumer. The display 46 can be transparent when not in use and partially transparent when in use to minimize the obstruction of the consumer's field of view through the display 46.

The forward facing camera 42 and display 46 of the head mountable unit 14 can be generally aligned such that the display 46 overlaps the field of view of the camera 42. In other words, the camera 42 can be arranged so that a video signal generated by the camera 42 can contain a field of view substantially similar to the field of view of a consumer when looking through the display 46.

The transmitter 48 can be configured to transmit signals generated by the other components of the communications unit 20 from the head mountable unit 14. The processor 40 can direct signals generated by components of the communications unit 20 to the commerce sever 12 through the transmitter 48. The transmitter 48 can be an electrical communication element within the processor 40. In one example, the processor 40 is operable to direct the video and audio signals to the transmitter 40 and the transmitter 48 is operable to transmit the video signal and/or audio signal from the head mountable unit 14, such as to the commerce server 12 through the network 16.

The receiver 50 can be configured to receive signals and direct signals that are received to the processor 40 for further processing. The receiver 50 can be operable to receive transmissions from the network 16 and then communicate the transmissions to the processor 40. The receiver 50 can be an electrical communication element within the processor 40. In some embodiments of the present disclosure, the receiver 50 and the transmitter 48 can be an integral unit.

The transmitter 48 and receiver 50 can communicate over a Wi-Fi network, allowing the head mountable device 14 to exchange data wirelessly (using radio waves) over a computer network, including high-speed Internet connections. The transmitter 48 and receiver 50 can also apply Bluetooth® standards for exchanging data over short distances by using short-wavelength radio transmissions, and thus creating personal area network (PAN). The transmitter 48 and receiver 50 can also apply 3G or 4G, which is defined by the International Mobile Telecommunications-2000 (IMT-2000) specifications promulgated by the International Telecommunication Union.

The head mountable unit 14 can include one or more speakers 52. Each speaker 52 can be configured to emit sounds, messages, information, and any other audio signal to the consumer. The speaker 52 can be positioned within the consumer's range of hearing. Audio content transmitted by the commerce server 12 can be played for the consumer through the speaker 52. The receiver 50 can receive the audio signal from the commerce server 12 and direct the audio signal to the processor 40. The processor 40 can then control the speaker 52 to emit the audio content.

The direction sensor 54 can be configured to generate a direction signal that is indicative of the direction that the consumer is facing. The direction signal can be processed by the processor 40 or by the commerce server 12. For example, the direction sensor 54 can electrically communicate the direction signal containing direction data to the processor 40 and the processor 40 can control the transmitter 48 to transmit the direction signal to the commerce server 12 through the network 16. By way of example and not limitation, the direction signal can be useful in determining the identity of a product(s) visible in the video signal, as well as the location of the consumer within the retail store.

The direction sensor 54 can include a compass or another structure for deriving direction data. For example, the direction sensor 54 can include one or more Hall effect sensors. A Hall effect sensor is a transducer that varies its output voltage in response to a magnetic field. For example, the sensor operates as an analog transducer, directly returning a voltage. With a known magnetic field, its distance from the Hall plate can be determined. Using a group of sensors disposing about a periphery of a rotatable magnetic needle, the relative position of one end of the needle about the periphery can be deduced. It is noted that Hall effect sensors can be applied in other sensors of the head mountable unit 14.

The position sensor 56 can be configured to generate a position signal indicative of the position of the consumer within the retail store. The position sensor 56 can be configured to detect an absolute or relative position of the consumer wearing the head mountable unit 14. The position sensor 56 can electrically communicate a position signal containing position data to the processor 40 and the processor 40 can control the transmitter 48 to transmit the position signal to the commerce server 12 through the network 16.

Identifying the position of the consumer can be accomplished by radio, ultrasound or ultrasonic, infrared, or any combination thereof. The position sensor 56 can be a component of a real-time locating system (RTLS), which is used to identify the location of objects and people in real time within a building such as a retail store. The position sensor 56 can include a tag that communicates with fixed reference points in the retail store. The fixed reference points can receive wireless signals from the position sensor 56. The position signal can be processed to assist in determining one or more products that are proximate to the consumer and are visible in the video signal.

The orientation sensor 58 can be configured to generate an orientation signal indicative of the orientation of the consumer's head, such as the extent to which the consumer is looking downward, upward, or parallel to the ground. A gyroscope can be a component of the orientation sensor 58. The orientation sensor 58 can generate the orientation signal in response to the orientation that is detected and communicate the orientation signal to the processor 40. The orientation of the consumer's head can indicate whether the consumer is viewing a lower shelf, an upper shelf, or a middle shelf.

The accelerometer 60 can be configured to generate an acceleration signal indicative of the motion of the consumer. The acceleration signal can be processed to assist in determining if the consumer has slowed or stopped, tending to indicate that the consumer is evaluating one or more products for purchase. The accelerometer 60 can be a sensor that is operable to detect the motion of the consumer wearing the head mountable unit 14. The accelerometer 60 can generate a signal based on the movement that is detected and communicate the signal to the processor 40. The motion that is detected can be the acceleration of the consumer and the processor 40 can derive the velocity of the consumer from the acceleration. Alternatively, the commerce server 12 can process the acceleration signal to derive the velocity and acceleration of the consumer in the retail store.

The proximity sensor 62 can be operable to detect the presence of nearby objects without any physical contact. The proximity sensor 62 can apply an electromagnetic field or a beam of electromagnetic radiation such infrared and assess changes in the field or in the return signal. Alternatively, the proximity sensor 62 can apply capacitive photoelectric principles or induction. The proximity sensor 62 can generate a proximity signal and communicate the proximity signal to the processor 40. The proximity sensor 62 can be useful in determining when a consumer has grasped and is inspecting a product.

The distance sensor 64 can be operable to detect a distance between an object and the head mountable unit 14. The distance sensor 64 can generate a distance signal and communicate the signal to the processor 40. The distance sensor 64 can apply a laser to determine distance. The direction of the laser can be aligned with the direction that the consumer is facing. The distance signal can be useful in determining the distance to an object in the video signal generated by one of the cameras 42, which can be useful in determining the consumer's location in the retail store. The distance sensor 64 can operate as a laser based system as known to those skilled in the art. In one exemplary embodiment of the present disclosure the laser based distance sensor 64 can double as a barcode scanner. In this form, the distance sensor 64 can be used with an augmented reality device either solely or in combination with a camera to read barcodes associated with products in a retail store.

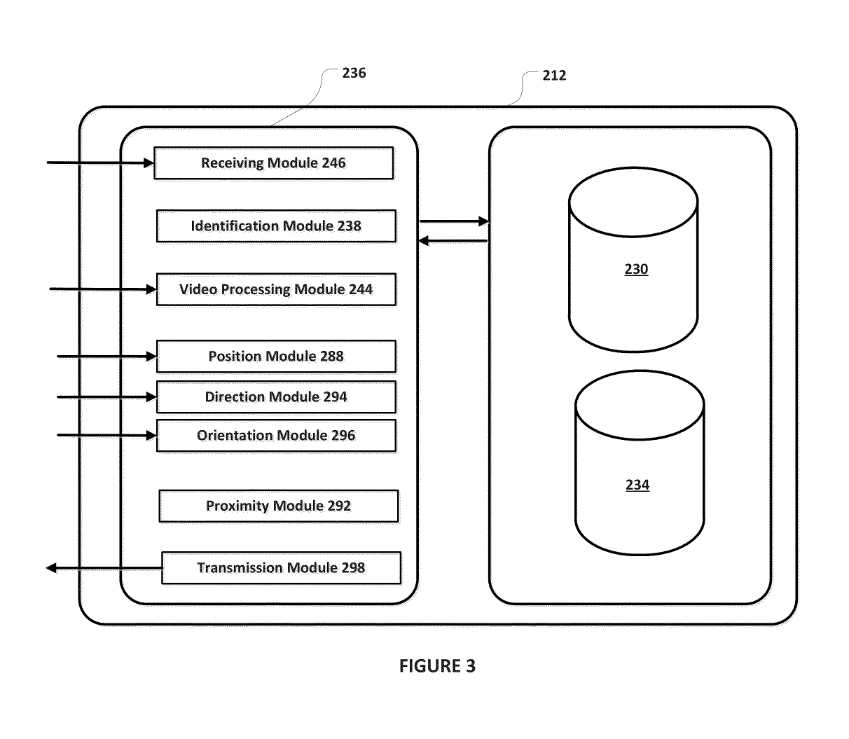

FIG. 3 is a block diagram illustrating a commerce server 212 according to some embodiments of the present disclosure. In the illustrated embodiment, the commerce server 212 can include a product database 230 and a consumer shopping list database 234. The commerce server 212 can also include a processing device 236 configured to include an identification module 238, a video processing module 244, a receiving module 246, a position module 288, a proximity module 292, a direction module 294, an orientation module 296 and a transmission module 298.

Any combination of one or more computer-usable or computer-readable media may be utilized in various embodiments of the disclosure. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

The product database 230 can include in memory the identities of a plurality of products offered for sale within a retail store. The plurality of products can be the products offered for sale in a retail store associated with the commerce server 212. The product database 230 can also contain a floor plan of the retail store, including the location of each of the plurality of products within the retail store. The product database 230 can also include image data of the appearance of each of the products offered for sale in the retail store. The data in the product database 230 can be organized based on one or more tables that may utilize one or more algorithms and/or indexes.

The consumer shopping list database 234 can include in memory lists of products that consumers desire to purchase in the retail store. The consumer shopping list database 234 can be configured to store more than one shopping list and can store more than one shopping list for a particular consumer. The data in the consumer shopping list database 234 can be organized based on one or more tables that may utilize one or more algorithms and/or indexes.

The processing device 236 can communicate with the databases 230, 234 and receive one or more signals from the head mountable unit 14 worn by the consumer. The processing device 236 can include computer readable memory storing computer readable instructions and one or more processors executing the computer readable instructions.

The receiving module 246 can receive one or more shopping list signals that contain a shopping list of products that the consumer desires to purchase in a retail store. The receiving module 220 can be operable to receive transmissions over the network 16 and then communicate the transmissions to other components of the commerce server 212. For example, the receiving module 220 can direct shopping list signals received from a consumer to the shopping list database 234 to establish a shopping list for a particular consumer.

The identification module 238 can be configured to select a product from the shopping list when the consumer enters the retail store to shop. The identification module 238 can access shopping lists stored in the shopping list database 234 and can be configured to select a product from the shopping list for the consumer to pursue. The identification module 238 can also access the product database 230 and identify the location of the product within the retail store.

The identification module 238 can function cooperatively with the position module 288. The position module 288 can receive the position signal from the position sensor 56 of the head mountable unit 14. The position signal can contain data corresponding to a location of the head mountable unit 14 within the retail store and thus the location of the consumer. The identification module 238 can receive the position signal from the position module 288. Based on the location of the consumer and the location of the product on the shopping list currently being pursued, the identification module 238 can derive directions for the consumer to reach the product on the shopping list currently being pursued.

The identification module 238 can also function cooperatively with the transmission module 298. The transmission module 298 can be configured to transmit direction signals to the head mountable unit 14 over the network 16. The direction signals can result in textual directions being displayed on the display 46 or audio directions being emitted from the speakers 52.

The video processing module 244 can be operable to receive a video signal from the head mountable unit 14. The video signal can be generated by the camera 42 of the head mountable unit 14 as the consumer traverses the retail store pursing a product on the shopping list. The video processing module 244 can analyze the video signal received from the head mountable unit 14. The video processing module 244 can implement known recognition/analysis techniques and algorithms to identify products appearing in the video signal, such as the product currently being pursued by the consumer.

The video processing module 244 can function cooperatively with the proximity module 292. The proximity module 292 can also function cooperatively with identification module 238, the position module 288, the direction module 294, and the orientation module 296.

The direction module 294 can receive the direction signal from the head mountable unit 14. The direction signal can be generated by the direction sensor 54 and contain data corresponding to a direction of the head mountable unit 14 within the retail store. The orientation module 296 can receive the orientation signal from the head mountable unit 14. The orientation signal can be generated by the orientation sensor 58 and contain data corresponding to an orientation of the head mountable unit 14 in the retail store. The orientation of the head mountable unit 14 corresponds to the orientation of the consumer's head and can vary between a downwardly orientation when the consumer is looking at a low shelf and an upwardly orientation when the consumer is looking at an upper shelf. The proximity module 292 can be configured to receive direction data from the direction module 294 and orientation data from the orientation module 296.

The proximity module 292 can also be configured to receive the location of the product currently being pursued from the identification module 238 and position data from the position module 288. The proximity module 292 can be configured to determine, in response to the data received from the modules 238, 288, 294, 296, that the product being pursued should be in the field of view of the camera 42 and thus also in the field of view of the consumer through the display 46.

When the data received from the modules 238, 288, 294, 296, indicates that the product being pursued should be in the field of view of the camera 42, the proximity module 292 can function cooperatively with the video processing module 244 and confirm that the product being pursued is visible in the video signal and is thus in the consumer's field of view. The proximity module 292 can then direct the transmission module 298 to send a proximity signal that changes the appearance of the display 46 of the head mountable unit 14. The proximity signal can result in various changes in the appearance of the display 46.

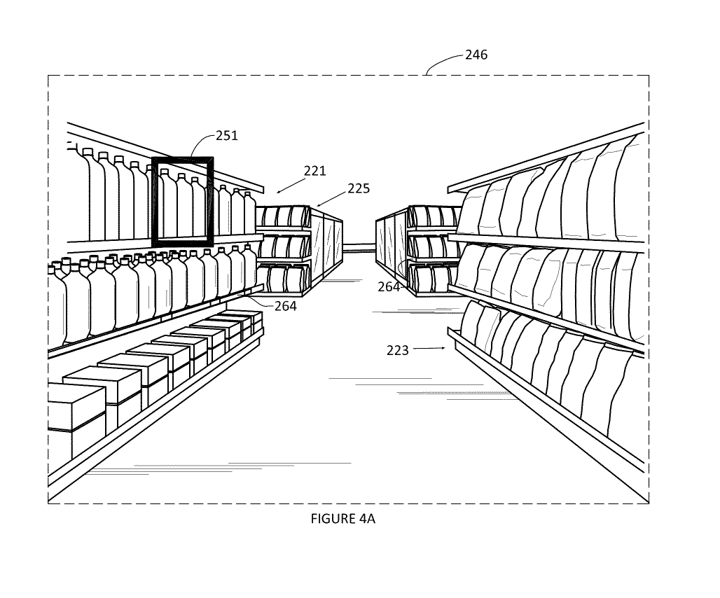

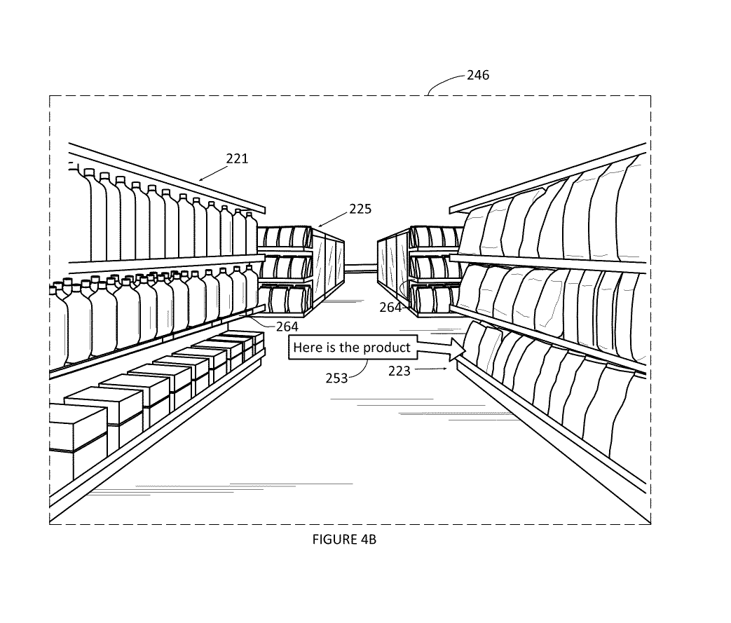

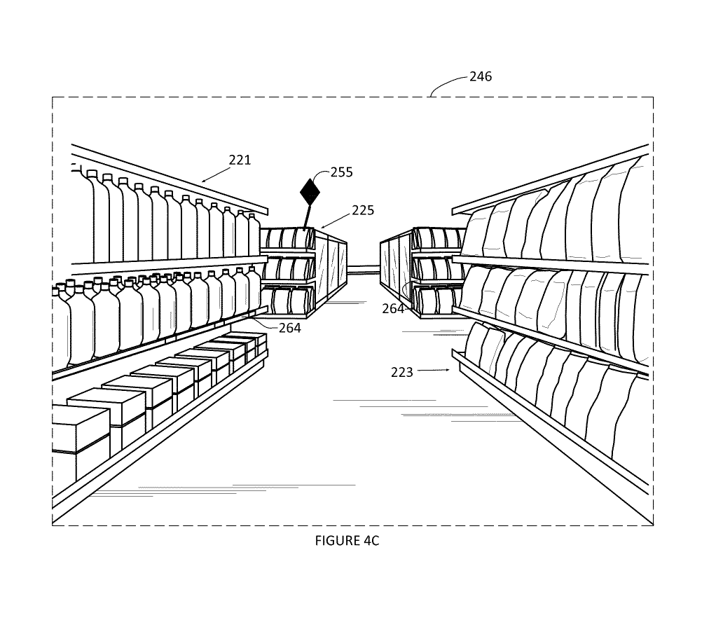

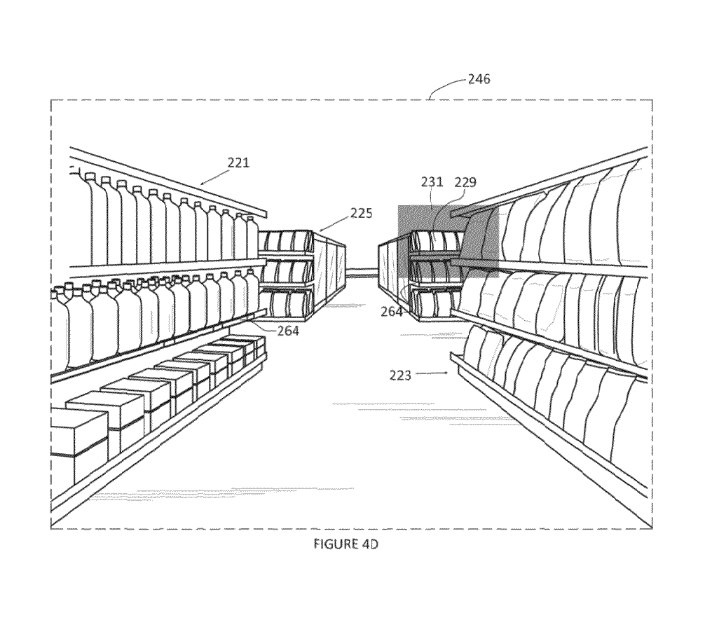

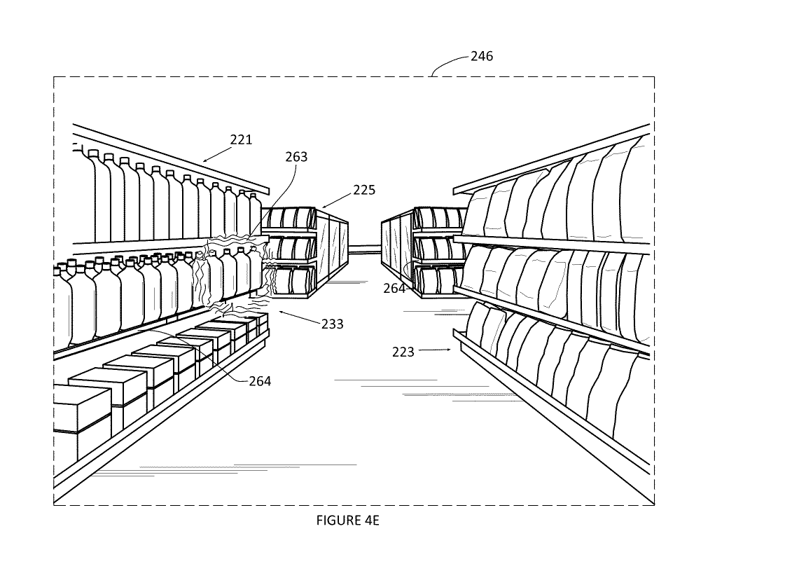

FIGS. 4A-4E illustrate a display 246 that can correspond to the view visible to a consumer when a proximity signal has been received in some embodiments of the present disclosure. In FIG. 4A, a plurality of products 221, 223, 225 are disposed on various shelves 264. For the exemplary embodiment of the present disclosure associated with FIG. 4A, the consumer can be pursuing the product 221.

Generally, the display 246 can be transparent and allow the consumer to see the products 221, 223, 225 and shelves 264. When the proximity module 292 of the commerce server 212 determines that the product 221 is visible through the display 246, the proximity module 292 can direct the transmission module 298 to transmit a proximity signal to the head mountable unit 14. In response to the proximity signal, the display 246 can be controlled by the processor 40 to change such that a box or outline 251 appears around at least one example of the product 221. The outline 251 is an exemplary highlighting feature. The view of the product 221 is thus augmented to attract the consumer's focus. The exemplary outline 251 is shown as rectangle of solid line, however other shapes and line configurations are contemplated by this disclosure, as well as any color of line.

FIG. 4B is analogous to FIG. 4A in that both figures show the products 221, 223, 225 on shelves 264. For the exemplary embodiment of the present disclosure associated with FIG. 4B, the consumer can be pursuing the product 223. In response to the proximity signal, the display 246 can be controlled by the processor 40 to change such that a text box 253 appears to direct the consumer's attention to the product 223. In this particular example the text states “Here is the product,” but it should be understood that a text box could include any words or phrases that may be helpful to attract the consumer's attention.

FIG. 4C is analogous to FIGS. 4A and 4B in that all three figures show the products 221, 223, 225 on shelves 264. For the exemplary embodiment of the present disclosure associated with FIG. 4C, the consumer can be pursuing the product 225. In response to the proximity signal, the display 246 can be controlled by the processor 40 to change such that a diamond-shaped symbol 255 and leader line appears above the product 225. Other symbols can be applied in other embodiments of the present disclosure.

FIG. 4D is analogous to FIGS. 4A-4C in that the figures show the products 221, 223, 225 on shelves 264. For the exemplary embodiment of the present disclosure associated with FIG. 4D, the consumer can be pursuing a product 229. In response to the proximity signal, the display 246 can be controlled by the processor 40 to change such that a different level of illumination envelopes the product 229 with respect to the illumination of the product 229. This darkened area of the displayed is referenced at 231.

FIG. 4E is analogous to FIGS. 4A-4D in that the figures show the products 221, 223, 225 on shelves 264. For the exemplary embodiment of the present disclosure associated with FIG. 4E, the consumer can be pursuing a product 233, positioned below the product 221. In response to the proximity signal, the display 246 can be controlled by the processor 40 to change such that different levels of focus are applied. The product 233 is visible but the region of the display around the product 233 is visibly distorted. This region is referenced at 263.

It is noted that the various processing functions set forth above can be executed differently than described above in order to enhance the efficiency of an embodiment of the present disclosure in a particular operating environment. The processor 40 can assume a greater role in processing some of the signals in some embodiments of the present disclosure. For example, in some embodiments, the processor 40 on the head mountable unit 14 could modify the video stream to require less bandwidth. The processor 40 could convert a video signal containing color to black and white in order to reduce the bandwidth required for transmitting the video signal. In some embodiments, the processor 40 could crop the video, or sample the video and display frames of interest. A frame of interest could be a frame that is significantly different from other frames, such as a generally low quality video having an occasional high quality frame. Thus, in some embodiments, the processor 40 could selectively extract video or data of interest from a video signal containing data of interest and other data. Further, the processor 40 could process audio signals received through the microphone 44, such signals corresponding to audible commands from the consumer.

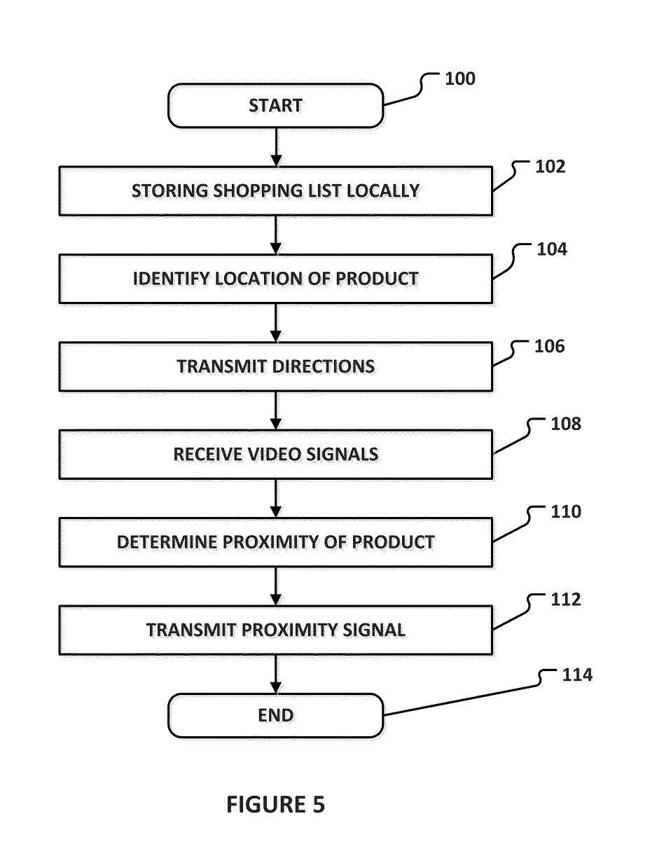

FIG. 5 is a flow chart illustrating a method that can be carried out in some embodiments of the present disclosure. The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

FIG. 5 illustrates a method can be executed by a commerce server. The commerce server can be located at the retail store or can be remote from the retail store. The method starts at step 100. At step 102, a shopping list of products that a consumer desires to purchase in a retail store can be stored locally at an augmented reality device worn by a consumer. At step 104, a product from the shopping list is identified for the consumer to pursue. At step 106, commerce server can transmit directions to the product based on the location of the identified product and the location of the consumer within the retail store. At step 108, the commerce server can receive a video signal as the consumer is moving through the retail store to acquire the current product being pursued. At step 110, the commerce server can determine that the product currently being pursed is proximate to the consumer. For example, the product can be within the field of view of the consumer. At step 112, the commerce server can transmit a proximity signal. The proximity signal can be received by an augmented reality device worn by the consumer. The receipt of the proximity signal by the augmented reality device can result in a highlighting or overlay feature being displayed to the consumer. The highlighting appearing in the display of the augmented reality device will help the consumer more easily detect the product. The exemplary method ends at step 114.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The above description of illustrated examples of the present disclosure, including what is described in the Abstract, are not intended to be exhaustive or to be limitation to the precise forms disclosed. While specific embodiments of, and examples for, the present disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A computer-implemented method comprising:
storing locally, at an augmented reality device worn by a consumer, a shopping list of products that a consumer desires to purchase in a retail store;
identifying, with a processing device of a commerce server, a location within the retail store of a product on the shopping list and a location of the consumer within the retail store;
transmitting, with the processing device, directions from the location of the consumer to the location of the product, the directions being transmitted to an augmented reality device worn by the consumer in the retail store;
receiving, with the processing device, a video signal from a camera of the augmented reality device as the consumer moves through the retail store;
determining, with the processing device, when the product is within a field of view of a camera; and
transmitting, with the processing device, a proximity signal to the consumer in response to the determining step.

2. The computer-implemented method of claim 1 wherein the step of transmitting the proximity signal further comprises:
transmitting, with the processing device, the proximity signal to the augmented reality device causing a change on a region of a display of the augmented reality device that is proximate to a position of the product on the display.

3. The computer-implemented method of claim 1 wherein the step of transmitting the proximity signal further comprises:
generating, with the processing device, a visibly observable feature on a display of the augmented reality device to augment a natural view of the product.

4. The computer-implemented method of claim 3 wherein the generating step further comprises:
generating, with the processing device, a visibly observable feature on a display of the augmented reality device to augment a natural view of the product, the visibly observable feature being an outline around the product.

5. The computer-implemented method of claim 3 wherein the generating step further comprises:
generating, with the processing device, a visibly observable feature on a display of the augmented reality device to augment a natural view of the product, the visibly observable feature being text.

6. The computer-implemented method of claim 3 wherein the generating step further comprises:
generating, with the processing device, a visibly observable feature on a display of the augmented reality device to augment a natural view of the product, the visibly observable feature being a symbol proximate to the product.

7. The computer-implemented method of claim 3 wherein the generating step further comprises:
generating, with the processing device, a visibly observable feature on a display of the augmented reality device to augment a natural view of the product, the visibly observable feature being differential illumination between the product and proximate, adjacent products.

8. The computer-implemented method of claim 3 wherein the generating step further comprises:
generating, with the processing device, a visibly observable feature on a display of the augmented reality device to augment a natural view of the product, the visibly observable feature being a variation in focus between the product and proximate, adjacent products.

9. The computer-implemented method of claim 1 wherein said determining step further comprises:
determining, with the processing device, when the product is within a field of view of a camera based on the video signal.

10. The computer-implemented method of claim 9 further comprising:
receiving, at the processing device of the commerce server, a position signal containing the position of the augmented reality device within the retail store.

11. The computer-implemented method of claim 10 wherein said determining step further comprises:
determining, with the processing device, when the product is within a field of view of a camera based on the video signal and the position signal.

12. The computer-implemented method of claim 9 further comprising:
receiving, at the processing device of the commerce server, a direction signal containing the direction of the augmented reality device within the retail store.

13. The computer-implemented method of claim 12 wherein said determining step further comprises:
determining, with the processing device, when the product is within a field of view of a camera based on the video signal and the direction signal.

14. The computer-implemented method of claim 9 further comprising:
receiving, at the processing device of the commerce server, an orientation signal containing the orientation of the augmented reality device within the retail store.

15. The computer-implemented method of claim 14 wherein said determining step further comprises:
determining, with the processing device, when the product is within a field of view of a camera based on the video signal and the direction signal.

16. The computer-implemented method of claim 1 further comprising:
receiving, at the processing device of the commerce server, the shopping list of products that the consumer desires to purchase in the retail store.

17. A consumer assistance system comprising:
a product database containing identities of products in a retail store and locations of each of the products within the retail store; and
a commerce server including a processing device configured to receive a shopping list of products that a consumer desires to purchase in a retail store and having:
a receiving module configured to receive a shopping list of products that a consumer desires to purchase in a retail store;
an identification module configured to identify a location within the retail store of a product on the shopping list and a location of the consumer within the retail store and derive directions from the location of the consumer to the location of the product;
a video processing module configured to receive video signals from a camera of an augmented reality device worn by the consumer as the consumer moves through the retail store;
a proximity module configured to determine when the product is within a field of view of a camera; and
a transmission module configured to transmit the directions and a proximity signal to the consumer when the product is within a field of view of a camera.

18. The consumer assistance system of claim 17 further comprising:
a shopping list database containing a plurality of shopping lists of products offered for sale in the retail store, wherein said identification module is configured to access the shopping list database and select a product from one of the plurality of shopping lists.

19. The consumer assistance system of claim 17 further comprising:
a position module configured to detect a position of the augmented reality device within the retail store, wherein said proximity module is configured to received the position from the position module and determine when the product is within a field of view of a camera based at least in part on the position.

20. The consumer assistance system of claim 19 further comprising:
a direction module configured to detect a direction of the augmented reality device within the retail store, wherein said proximity module is configured to received the direction from the direction module and determine when the product is within a field of view of a camera based at least in part on the direction.
